(19) United States
(12) Patent Application Publication
(10) Pub. No.: US 2007/0183607 A1
(43) Pub. Date: Aug. 9, 2007

(54) Directional listening device

(75) Inventors: Michael R. Andrews, Phoenix, AZ (US); Carolyn C. Andrews, Phoenix, AZ (US); Terry L. Steffey, Scottsdale, AZ (US)

Correspondence Address: Paul F. Wille, 6407 E. Clinton St., Scottsdale, AZ, 85254, US

(73) Assignee: Sound & Optics Systems, Inc., Scottsdale, AZ (US)

(21) Appl. No.: 11/350,693

(22) Filed: Feb. 9, 2006

(51) Int. Cl. H04R 25/00; H04R 9/08; H04R 19/04

(52) U.S. Cl. 381/160; 381/356; 181/191

(57) ABSTRACT

A directional listening device includes a reflector having a central axis, a microphone pointing toward the reflector and positioned along the central axis, and a collimator or shield surrounding the microphone and aligned with the reflector for improved directionality. The device also includes a laser pointing away from the reflector and a fitting for receiving a sighting device for aiming the listening device. Handles attached to the listening device have a resilient cover for noise reduction.

### BACKGROUND

This application relates to a listening device that gathers sound for a microphone and, in particular, to a directional listening system in which sound is collimated.

Listening devices using a curved reflector to gather sound for one or more microphones are also well known in the art, e.g. see U.S. Pat. No. 4,037,052 (Doi). It is known also to try to track a sound, i.e. point a microphone in the direction of the source of the sound; e.g. see U.S. Pat. No. 5,452,364 (Bonham). For many applications, accurate direction finding can be critical, e.g. search and rescue. In such applications, the listening device must also be rugged because, once a victim is found, care for the device is secondary to rescue.

A problem with systems of the prior art is the reliance on a reflector, typically parabolic but occasionally hemispherical. Such a reflector has a wide acceptance angle, making it difficult to locate the source of a sound. The sound at any point in space is a complex combination of the original sound and reflections from many objects. A parabolic reflector affects sounds differently at different frequencies. With plural microphones, the problem is more complicated but not resolved. Sounds from behind a curved reflector can be coupled to the reflector by nearby buildings, for example.

Another problem with systems of the prior art is that, even if the listening device is pointing in the proper direction, the user may not realize exactly what that direction is, particularly with hand-held reflectors. For example, U.S. Pat. No. 5,526,433 (Zakarauskas et al.) attempts to overcome this problem by providing a platform and a gimbal mount for holding a reflector. This merely transfers the problem to another element. The platform must be calibrated for the direction indicated by the gimbal mount in order to have meaning.

Yet another problem with systems of the prior art is that one may be listening for a faint sound. Sounds mechanically coupled to the microphone can be louder than the faint sound that one is trying to locate. In such case, a faint sound of interest may be overlooked. In search and rescue operations, this can be critical, whether the sound is a human voice or the sound of a support cracking. Even for more mundane operations, such as listening for termites or carpenter ants, mechanically coupled sounds can be at least an inconvenience, if not a source of error.

In view of the foregoing, it is therefore an object of the invention to provide a directional listening device having a narrower acceptance angle than listening devices of the prior art.

Another object of the invention is to provide a directional listening device that accurately indicates the direction to a source of sound.

A further object of the invention is to provide a directional listening device that accurately indicates the direction to a source of sound without prior calibration or alignment.

Another object of the invention is to provide a listening device that can detect faint sounds without interference from mechanically coupled sounds.

### SUMMARY OF THE INVENTION

The foregoing objects are achieved by this invention in which a directional listening device includes a reflector having a central axis, a microphone pointing toward the reflector and positioned along the central axis, and a collimator or shield surrounding the microphone and aligned with the reflector for improved directionality. The device also includes a laser pointing away from the reflector and a fitting for receiving a sighting device for aiming the listening device. Handles attached to the listening device have a resilient cover for noise reduction.

### BRIEF DESCRIPTION OF THE DRAWINGS

A more complete understanding of the invention can be obtained by considering the following detailed description in conjunction with the accompanying drawings, in which:

FIG. 1 is a perspective front view of a directional listening device constructed in accordance with a preferred embodiment of the invention;

FIG. 2 illustrates the geometry of a listening device constructed in accordance with the invention;

FIG. 3 is a perspective rear view of a directional listening device constructed in accordance with a preferred embodiment of the invention; and

FIG. 4 is a block diagram of the electronics used in a directional listening device constructed in accordance with the invention.

### DETAILED DESCRIPTION OF THE INVENTION

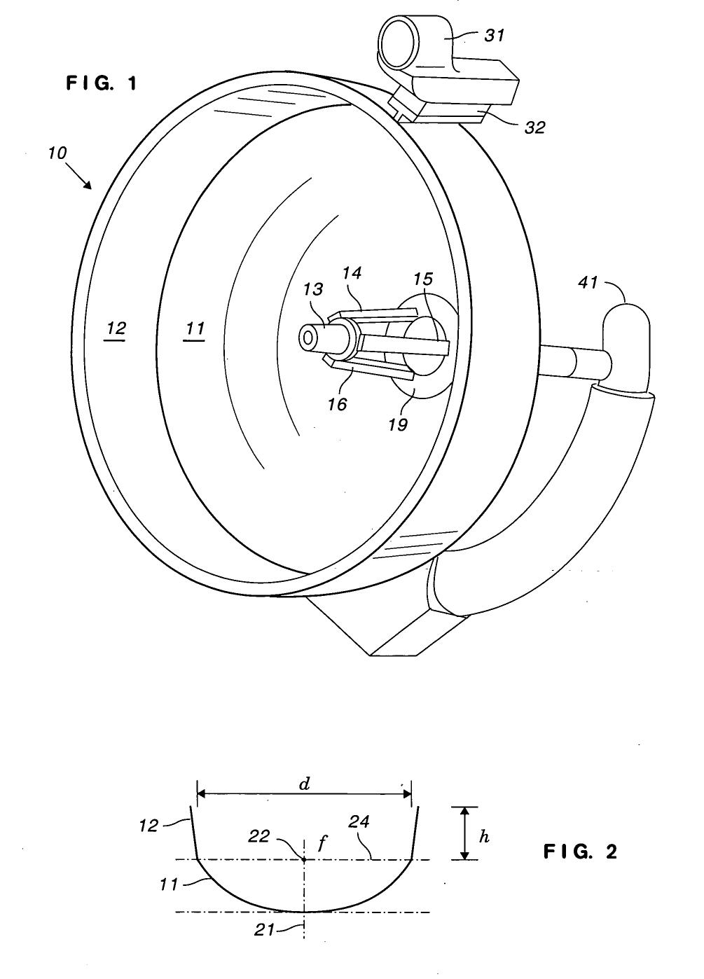

In FIG. 1, directional listening device 10 includes curved reflector 11 and collimator 12. Housing 13 is spaced from the inner surface of reflector 11 by posts 14, 15, and 16, which, with housing 13, form a pedestal or mounting for a microphone (not shown in FIG. 1) and a laser (not shown in FIG. 1). The microphone faces the inner or concave surface of reflector 11 and the laser point outward, substantially along the axis of reflector 11. The lengths of posts 14, 15, and 16 are substantially equal for holding housing 13 on the central axis of reflector 11 and substantially parallel with the central axis of reflector 11. The posts are attached to disk 19, which is preferably fastened to reflector 11 by an adhesive. Reflector 11 and collimator 12 are preferably molded from a suitable plastic, such as polycarbonate (such as Lexan® brand polycarbonate).

FIG. 2 is a diagram illustrating the geometric relationship of reflector 11 and collimator 12. Reflector 11 is preferably a paraboloid, having central axis 21 and focus 22 intersecting the central axis. A microphone (not shown in FIG. 2) is preferably located at the focal point. In a preferred embodiment of the invention, The depth of reflector 11 is approximately equal to the focal length. That is, reflector 11 has a diameter d approximately equal to the length of a chord through focal point 22 along line 24.

Reflector 11 does not require geometrical precision for operation, even if the parabola itself has been known and studied for thousands of years. One is dealing with competing interests, such as portability, manufacturability, and cost, in addition to functionality. Thus, reflector 11 can be approximately parabolic, have a focal length of two to four inches, and have a diameter d of six to twelve inches and still be relatively portable and light enough to be aimed or scanned for long periods of time, if need be. The focal length does not dictate the diameter or depth of reflector 11, nor vice-versa.

Reflector 11 is preferably a paraboloid, although this is not critical. Hyperboloids, ellipsoids and spheroids can be used instead for reflector 11. A surface of revolution is a preferred reflecting surface to avoid asymmetries in response if directional listening device 10 is not held in its expected orientation.

Whatever directionality, if any, a reflector provides, it is not as good as desired for rescue work. In accordance with one aspect of the invention, the addition of collimator 12 significantly improves directionality, particularly for sounds coming from behind reflector 11, despite the small height of the collimator relative to the diameter of the reflector. In a preferred embodiment of the invention, collimator 12 has a height h approximately equal to the focal length of reflector 11; that is, collimator 12 approximately doubles the depth of directional listening device 10. As with reflector 11, collimator 12 is a trade-off among competing interests, including functionality. Collimator 12 provides a substantial improvement without making directional listening device 10 ungainly to use.

As illustrated in FIG. 2. collimator 12 increases in diameter with increasing height; that is, collimator 12 is illustrated as a conic section, not a cylinder. A conic section simplifies manufacturing; specifically, simplifies release from a mold. The angle chosen for collimator 12 is approximately seven degrees. Other shallow angles are suitable.

In a preferred embodiment of the invention, reflector 11 and collimator 12 are molded as a single piece, which means that collimator 12 is as much a reflector as reflector 11. It has not been found necessary to treat the inner surface of collimator 12 to reduce reflection, although this could certainly be done, if desired; e.g. roughening the inner surface of collimator 12 or adding a sound absorbing layer. A unitary structure provides greater strength and reduced stress along the joint between the two components.

In accordance with another aspect of the invention and referring to FIG. 1, sighting device 31 is attached to the outside wall of collimator 12 by adapter 32, which offsets the taper in collimator 12. In one embodiment of the invention, sighting device 31 is what is known as a red dot sight. These sights project a red dot onto a sight image, indicating where directional listening device 10 is pointing. Red dot sights are commonly used for target shooting with pistols and have a long “eye relief,” the distance from the sight to the eye, making the sights convenient to use with directional listening device 10. Sighting device 31 couples to adapter 32 by a suitably sturdy and stable connection, such as a sliding dovetail joint, that will hold sighting device 31 in alignment with reflector 11 and the laser in housing 13.

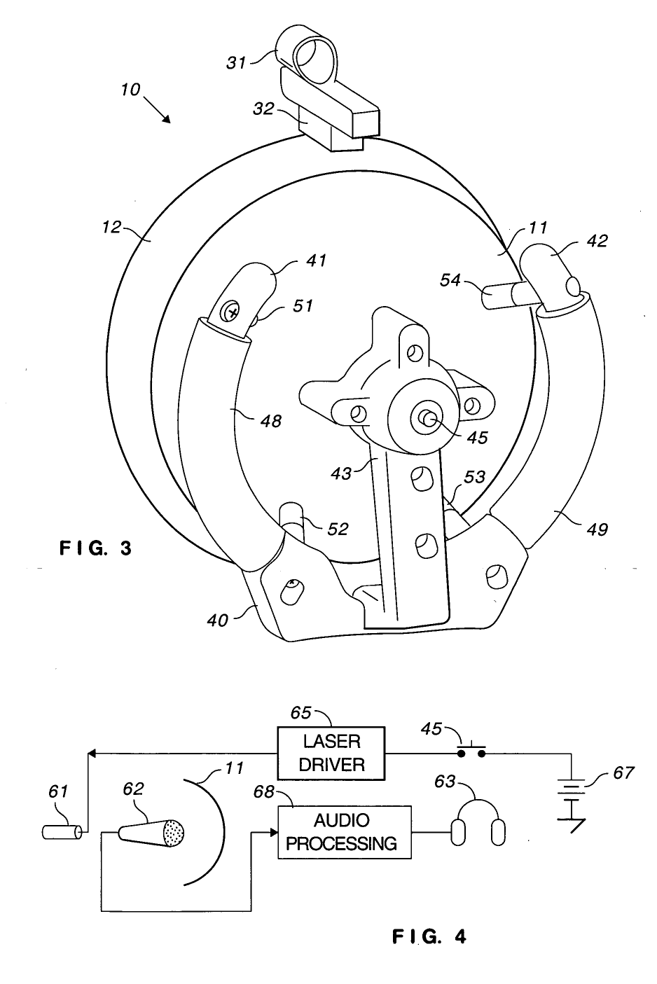

Handle 41 is described in conjunction with FIG. 3.

In FIG. 3, handle 41 is part of bracket 40, which includes handle 41, handle 42, and hand grip 43. Push button switch 45 turns the laser on and off and is accessible from handle 41, handle 42, or hand grip 43. A laser pointer is useful for confirming point of aim but may not be visible in direct sunlight. Sighting device 31 is useful under almost any lighting conditions but may suffer from problems of parallax at close range or with large diameter reflectors. (Parallax results from sighting device 31 not being on the central axis of reflector 11. If sighting device 31 were aligned parallel to the central axis of reflector 11, it would point to a spot above the central axis by approximately one half the diameter of the reflector.) For most applications, the problem of parallax is insignificant.

Bracket 40 holds handle 41, handle 42, and grip 43 in spaced apart relationship and the assembly is attached to the rear surface of reflector 11 by four screws. Disk 19 (FIG. 1) is at the front portion of the upper end of grip 43 and fits within a closely matched hole in reflector 11. A suitable adhesive between disk 19 and reflector 11 secures the two and, with the four pins, provides a stable, rugged, and substantially self-aligned support for housing 13.

In accordance with another aspect of the invention, handles 41 and 42 each include a resilient cover, like the cushioned grips on the handlebars of a bicycle. Handle 41 includes cover 48 and handle 42 includes cover 49. Hand grip 43 could include a cover if desired but serves more as a carrying handle than a handle for carefully scanning an area, which is more steadily done with two hands. The covers absorb mechanical vibration and block or attenuate the vibration to avoid mechanically coupling noise to the microphone in housing 13 (FIG. 1). Bracket 40 is further acoustically isolated from reflector 11 by stand-off insulators 51, 52, 53, and 54 that attach bracket 40 to the outside or convex side of reflector 11. The insulators are also resilient and further isolate the microphone from mechanically coupled noise.

FIG. 4 is a block diagram of the electronics used with a directional listening device constructed in accordance with the invention. The electronics, except for laser 61, microphone 62, and headphones 63, is preferably contained within bracket 40 and grip 43. As described above, laser 61 and microphone 62 are located in housing 13 (FIG. 1). Laser 61 is of the type used for battery powered pointers. Microphone 62 is preferably an omnidirectional electret microphone. Laser 61 and microphone 62 point in opposite directions along the central axis of reflector 11, with microphone 62 pointed at reflector 11.

Laser 61 is powered by driver 65 and is preferably operated intermittently. A user depresses momentary contact, push button switch 45 to couple driver 65 to power source 67, illustrated as a battery. Laser 61 and driver 65 are usually available commercially as a single unit.

Audio processing circuit 68 is coupled to microphone 62 and provides a suitable output signal for headphones 63. Audio processing circuit 68 includes variable gain, controlled by a user, and automatic gain control, to prevent unexpected loud noises from overloading the circuitry or damaging a user's hearing. Additional signal processing, such as spectrum filtering, frequency selective gain, noise cancellation, and echo cancellation, can be included as needed or desired for a particular application. The signal processing can be analog or digital.

The invention thus provides a directional listening device having a narrower acceptance angle than listening devices of the prior art and accurately indicates the direction to a source of sound. Except for initial alignment during manufacture, the directional listening device accurately indicates the direction to a source of sound without further calibration or alignment. The directional listening device detects faint sounds without interference from mechanically coupled sounds through the handles for holding the device.

Having thus described the invention, it will be apparent to those of skill in the art that various modifications can be made within the scope of the invention. For example, collimator 12 could be cylindrical if wall thickness were tapered to facilitate release from a mold. The type of sight is not critical. Red dot sights have little or no magnification. If desired, a standard mount, such as a Weaver rail, can be attached to collimator 12. In this way, any sight that a person happens to use or to prefer can be attached to the directional listening device by means of the rail. While illustrated as a hand-held device, a directional listening device constructed in accordance with the invention can be fitted with a tripod mount or other mounting system suitable for a specific application, particularly if the directional listening device is scaled to a significantly larger size; e.g., a diameter of more than eighteen inches. A fitting for receiving sighting device 31 could be mounted on bracket 40, handle 41, handle 42, or grip 43. For smaller diameters, e.g. less than eight inches, handle 41 and handle 42 can be eliminated. Microphones other than omnidirectional electret microphones can be used for microphone 62.

What is claimed as the invention is:

1. A directional listening device comprising:
an acoustic reflector having a central axis;
a microphone positioned along said central axis; and
an acoustic collimator surrounding said microphone and aligned with said acoustic reflector.

2. The directional listening device as set forth in claim 1 wherein said reflector has a first diameter and said collimator has a second diameter, wherein said first diameter and said second diameter are substantially equal.

3. The directional listening device as set forth in claim 1 wherein said reflector and said collimator are molded as a single piece.

4. The directional listening device as set forth in claim 1 and further including a fitting for receiving an optical sighting device.

5. The directional listening device as set forth in claim 4 wherein said fitting is attached to said collimator.

6. The directional listening device as set forth in claim 1 wherein said reflector is a surface of rotation.

7. The directional listening device as set forth in claim 1 wherein said reflector is a paraboloid.

8. The directional listening device as set forth in claim 1 wherein said collimator is a conic section.

9. The directional listening device as set forth in claim 1 wherein said collimator is cylindrical.

10. The directional listening device as set forth in claim 1 and further including handles attached to said reflector.

11. The directional listening device as set forth in claim 10 wherein said handles are resiliently attached to said reflector to reduce coupling noise to said microphone.

12. The directional listening device as set forth in claim 11 wherein said handles include cushioned grips to reduce coupling noise to said microphone.

13. The directional listening device as set forth in claim 10 wherein said handles include cushioned grips to reduce coupling noise to said microphone.

14. A directional listening device comprising:
an acoustic reflector having a parabolic cross-section, said parabolic cross-section defining a central axis and a focus;
a microphone positioned substantially at said focus;
an acoustic collimator in the form of a conic section having an axis aligned with said central axis;
wherein said acoustic reflector has a first diameter approximately equal to the length of a chord through said focus and orthogonal to said central axis; and
wherein said acoustic collimator has a second diameter substantially equal to said first diameter.

15. The directional listening device as set forth in claim 14 wherein said acoustic collimator has a dimension along said central axis substantially equal to the focal length of said parabolic cross-section.

16. The directional listening device as set forth in claim 14 and further including a fitting for receiving an optical sighting device.

17. The directional listening device as set forth in claim 14 and further including handles attached to said reflector.

18. The directional listening device as set forth in claim 17 wherein said handles are resiliently attached to said reflector to reduce coupling noise to said microphone.

19. The directional listening device as set forth in claim 18 wherein said handles include cushioned grips to reduce coupling noise to said microphone.

20. The directional listening device as set forth in claim 17 wherein said handles include cushioned grips to reduce coupling noise to said microphone.
